(19) United States
(12) Patent Application Publication
(10) Pub. No.: US 2014/0379364 A1
(43) Pub. Date: Dec. 25, 2014

(54) INTELLIGENT COMPUTER-GUIDED STRUCTURED REPORTING FOR EFFICIENCY AND CLINICAL DECISION SUPPORT

(71) Applicant: KONINKLIJKE PHILIPS N.V., Eindhoven (NL)

(72) Inventors: XIN LIU, SCARSDALE, NY (US); YUECHEN QIAN, BRIARCLIFF MANOR, NY (US); LILLA BOROCZKY, MOUNT KISCO, NY (US); QI ZHONG LIN, SHANGHAI (CN); GEORGE HUANG, SHANGHAI (CN)

(21) Appl. No.: 14/309,949

(22) Filed: Jun. 20, 2014

Related U.S. Application Data
(60) Provisional application No. 61/837,231, filed on Jun. 20, 2013.

(51) Int. Cl. G06F 19/00; G06F 3/0484; G06F 3/0481

(52) U.S. Cl. CPC G06F 19/363; G06F 3/0481; G06F 3/04842; G06F 19/3406
USPC 705/2

(57) ABSTRACT

A method includes receiving a signal indicative of an experience level of a clinician evaluating patient data, and, in response to determining whether the experience level satisfies a predetermined experience level threshold, prompting, via a graphical user interface, for an input indicating a first impression based on the evaluation of the patient data, automatically populating a first sub-set of the fields in the electronically formatted structured medical report based on the first impression, populating a second different sub-set of the fields in the electronically formatted structured medical report based on an input indicative of clinician selected entries, finalizing the electronically formatted structured medical report in response to clinician confirmation of the populated electronically formatted structured medical report, and storing the finalized electronically formatted structured medical report in a data repository.

The following generally relates to medical reporting and more particularly to computer guided structured reporting.

A clinician can add information to a medical report for a patient by dictating into a recording device and having the dictation transcribed into electronic format either by a person or a machine (e.g., transcription software running on a computer). Clinicians have done so using “free language,” or terms and sentence/clause structure preferred by the individual clinicians, which may vary from clinician to clinician.

More recently, clinicians have used electronic “structured reporting” which is based on a unified and standardized nomenclature. This facilitates the communication of medical reports between clinicians and/or departments, and allows seamless integration of medical reports to modern-day electronic medical records (EMR).

Unfortunately, such reporting may be tedious for a clinician in that the clinician has to manually fill in (e.g., type or select from a menu via a mouse, touch screen or key board) all the entries (which may be numerous) in all the fields of a structured report using a computer. Furthermore, an experienced clinician may arrive at a decision (e.g., whether a lesion is benign or malignant) before all the fields are even filled in.

For less experienced clinicians, although structured reporting may help them organize the findings and mitigate missing a feature, correctly characterizing features remains challenging. By way of example, if a clinician is not experienced enough to sufficiently differentiate from the images, e.g., fuzzy boundary versus smooth boundary, the clinician may arrive at an incorrect assessment.

Aspects described herein address the above-referenced problems and others.

In one aspect, a method includes receiving a signal indicative of an experience level of a clinician evaluating patient data, and, in response to determining whether the experience level satisfies a predetermined experience level threshold, prompting, via a graphical user interface, for an input indicating a first impression based on the evaluation of the patient data, automatically populating a first sub-set of the fields in the electronically formatted structured medical report based on the first impression, populating a second different sub-set of the fields in the electronically formatted structured medical report based on an input indicative of clinician selected entries, finalizing the electronically formatted structured medical report in response to clinician confirmation of the populated electronically formatted structured medical report, and storing the finalized electronically formatted structured medical report in a data repository.

In another aspect, a computing apparatus includes a computer readable storage medium including instructions for populating fields of an electronically formatted structured medical report for patient data and a processor that executes the instructions. Executing the instructions results in receiving a signal indicative of an experience level of a clinician evaluating the patient data, and, in response to determining whether the experience level satisfies a predetermined experience level threshold, prompting, via the graphical user interface, for an input indicating a first impression based on the evaluation of the patient data, automatically populating a first sub-set of the fields in the electronically formatted structured medical report based on the first impression, populating a second different sub-set of the fields in the electronically formatted structured medical report based on an input indicative of clinician selected entries, finalizing the electronically formatted structured medical report in response to clinician confirmation of the populated electronically formatted structured medical report, and storing the finalized electronically formatted structured medical report in a data repository.

In another aspect, a computer readable storage medium encoded with computer readable instructions, which, when executed by a processor, causes the processor to: prompt, via a graphical user interface, for an input indicating a first impression based on the evaluation of patient data, automatically populate a first sub-set of fields in an electronically formatted structured medical report for the patient data based on the first impression, populate a second different sub-set of the fields in the electronically formatted structured medical report based on an input indicative of clinician selected entries, finalize the electronically formatted structured medical report in response to clinician confirmation of the populated electronically formatted structured medical report, and store the finalized electronically formatted structured medical report in a data repository.

The invention may take form in various components and arrangements of components, and in various steps and arrangements of steps. The drawings are only for purposes of illustrating the preferred embodiments and are not to be construed as limiting the invention.

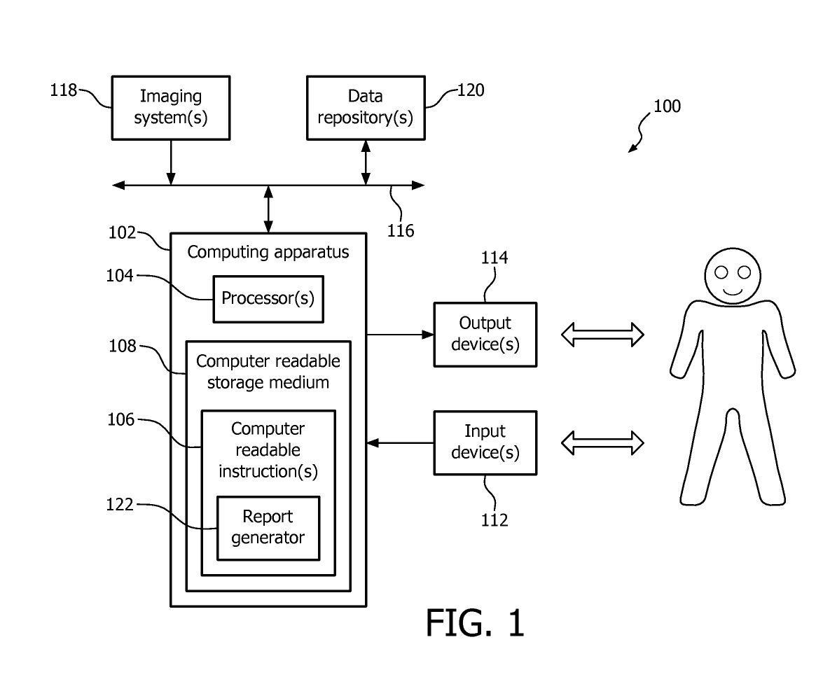

FIG. 1 schematically illustrates an example system including a computing apparatus with report generator that facilitates generating structured reports.

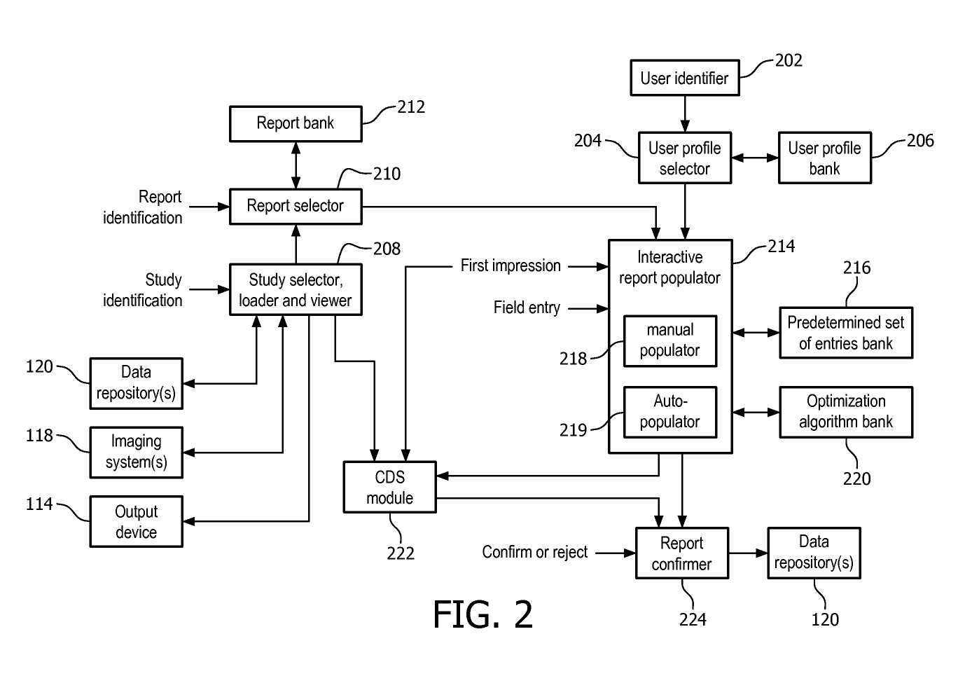

FIG. 2 illustrates an example of the report generator of the computing apparatus of FIG. 1.

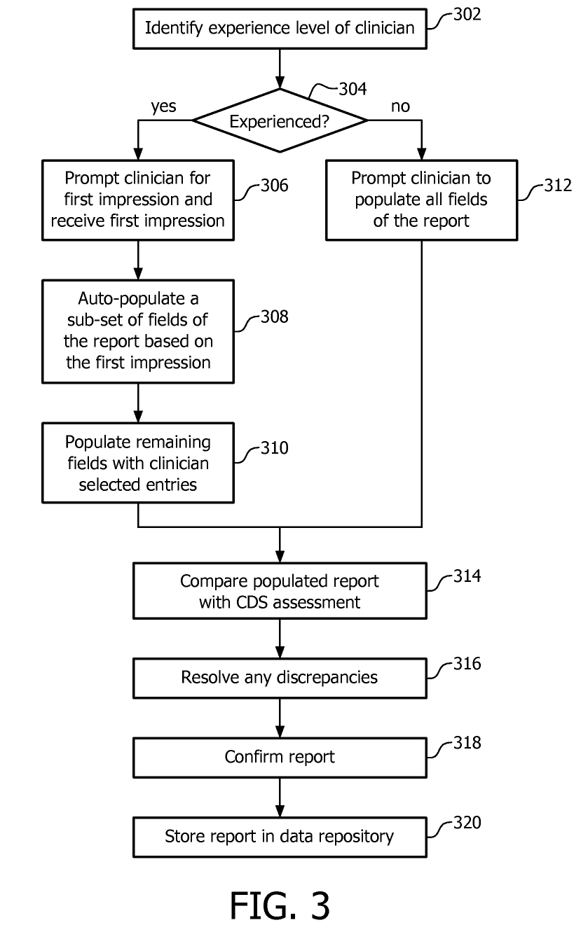

FIG. 3 illustrates an example method that facilitates generating structured reports.

The following describes an approach that facilitates populating fields of an electronic medical report by auto-filling entries of certain fields of the report based on a clinician's experience and first impression from evaluating patient data (e.g., reading image data, etc.). Optional features facilitate quickly identifying fields that are to be populated by the clinician, identifying entries in a set of entries for a field that are more correlated with the first impression, and/or double checking populated fields.

FIG. 1 illustrates a system 100 with a computing apparatus 102 that includes at least one processor 104, which executes one or more computer readable instructions 106 stored in computer readable storage medium 108, such as physical memory or other non-transitory storage medium. The processor 104 can additionally or alternatively execute one or more computer readable instructions carried by a carrier wave, a signal or other transitory (or non-computer readable storage) medium.

The computing apparatus 102 receives information from one or more input devices 112 such as a keyboard, a mouse, a touch screen, etc. and/or conveys information to one or more output devises 114 such as one or more display monitors. The illustrated computing apparatus 102 is also in communication with a network 116 and one or more devices in communication with the network such as one or more imaging system(s) 118, one or more data repositories 120, and/or one or more other devices.

Examples of imaging systems include, but are not limited to, a computed tomography (CT), a magnetic resonance (MR), a positron emission tomography (PET), a single photon emission computed tomography (SPECT), an ultrasound (US), and an X-ray imaging system. Examples data repositories 120 include, but are not limited to, a picture archiving and communication system (PACS), a radiology information system (RIS), a hospital information system (HIS), and an electronic medical record (EMR).

The computing apparatus 102 can be a general purpose computer or the like located at a physician's office, a health care facility, an imaging center, etc. The computing apparatus 102 at least includes software that allows authorized personnel to generate electronic medical reports. The computing apparatus 102 can convey and/or receive information using formats such as Health Level Seven (HL7), Extensible Markup Language (XML), Digital Imaging and Communications in Medicine (DICOM), and/or one or more other formats.

In the illustrated embodiment, the at least one computer readable instruction 106 includes electronic medical report generating instructions (report generator) 122, which when executed by the at least one processor 104 facilitates populating fields of an electronic medical report template with standardized nomenclature by auto-filling entries of certain fields of the electronic medical report template, with the standardized nomenclature, based on a clinician's experience, for example, and a first impression by the clinician from evaluating patient data.

Optionally, ordering and clustering is utilized to facilitate distinguishing fields that are to be populated by the clinician from fields that have been auto-populated. Optionally, sorting is utilized to highlight entries more correlated with the first impression. Optionally, a Clinical Decision Support (CDS) module identifies any discrepancies between a clinician created report and the CDS module's assessment of the patient data. The foregoing, in one instance, allows for reducing the amount of time it takes for a clinician to populate and generate a structured medical report, using standardized nomenclature.

FIG. 2 illustrates an example of the report generator 122 of FIG. 1 in connection with a data repository 120, an output device 114, an imaging device 116, and a data repository 120. For explanatory purposes and sake of brevity, the following example is discussed in the context of patient data that includes image data. However, as discussed herein, the patient data can include other patient data, for example, patient data sensed by a sensor(s) and/or other patient data.

A user identifier 202 identifies the clinician employing the computer apparatus 102. In one instance, this is achieved based on the log on and password of the clinician. In another instance, this is achieved based on a biometric such as a finger print, facial feature scan, etc. In one instance, this is achieved based on electronic information stored on an identification card such as a driver's license, an employee badge, and/or other identification device. In one instance, this is achieved based on voice recognition. Other approaches are also contemplated herein.

A user profile selector 204 receives the user identification and retrieves a pre-stored user profile for the clinician from a user profile bank 206. Where a profile does not exist, a default profile may be used, the clinician may be required to create a profile, or the computing apparatus 102 terminates execution of the report generating instructions 122. In one instance, the stored user profile indicates an experience of the clinician. For example, in one instance, the profile identifies whether the clinician has been practicing for at least a pre-determined threshold number of years. The threshold may distinguish whether the clinician is experienced (e.g., ≧5 years) or a more junior (e.g., <5 years) clinician.

A study selector, loader and viewer 208 receives a study identification, e.g., a signal indicative of an image study selected by the clinician, retrieves the study and loads the study in a viewer, which visually presents the image data to the clinician in an output device 114 such as a display monitor . The study selector, loader and viewer 208 may also include manipulation tools (e.g., zoom, pan, rotate, segment, etc.) and/or measurements tools (e.g., line, volume, etc.). The selected and loaded study may be from one of the imaging devices 116, one of the data repositories 120, and/or other device.

A report selector 210 selects a predetermined template report, from a report bank 212, to be filled in. In one instance, the clinician enters a report identification, and the report selector 210 selects a report based on the report identification. A report is selected for example from a list of available reports. The list of available reports is for example presented in a menu visually displayed via a graphical user interface on a display monitor. Alternatively, the report is for example identified through a keyboard and/or voice. In yet another instance, the report selector 210 selects the predetermined template report based on the selected study.

An interactive report populator 214 facilitates populating the selected predetermined template report. In the illustrated embodiment, this is achieved based on the selected report, the user profile and a first impression of the image provided by a reading of the image data by the clinician. The first impression, for example, can be made based on observation, manipulation and/or measurements of the visually displayed image data. A non-limiting example with respect to a lesion is: benign or malignant. A non-limiting example with respect to a bone is: bruised, simple fracture, or compound fracture.

Other information for the same or other tissue of interest are also contemplated herein. For example, optionally, a differential diagnosis (e.g. fibroadenoma, with respect to a breast lesion) can also be provided by the clinician and utilized. The first impression may be selected from a list of available entries, for example, displayed in a list or menu visually presented in a graphical user interface visually presented via a display monitor. Alternatively, the first impression may be entered via a keyboard, a voice command, or other approach.

The interactive report populator 214 retrieves a set of entries for the report from a predetermined set of entries bank 216. In the illustrated embodiment, this is achieved based on the selected report, the user profile and/or the first impression. For example, where the user profile indicates the clinician is a more junior clinician, there is no set of entries, and a manual populator 218 presents a list of available entries for the different fields of the report, and the clinician manually selects an entry for each field.

Where the user profile indicates the clinician is an experienced clinician, an auto populator 219 retrieves a set of entries or feature characteristics that are highly associated with the nature of the tissue of interest. For example, with respect to a lesion, if the first impression is benign, the set of entries would include entries: smooth boundary, solid, well-circumscribed, etc. An auto-populator 218 automatically populates these entries in the report. The manual populator 218 is then used to populate fields that were not auto-populated.

Optionally, one or more optimization algorithms, for optimizing filing in report entries, from an optimization algorithm bank 220 are used to facilitate completing populating the report.

For example, in one instance, all features (such as calcification, coopers ligament change, shape, margin, orientation, etc.) that have strong indication of benign relative to malignant would be ordered and clustered into a same zone and visually presented together in a predetermined location of the user interface, or highlighted with a different shade, gray level or color. The change of the cluster of feature groups based on the first impression of the lesion may streamline the report-filling process.

In another example, entries that exist in a list or drop-down menu are automatically sorted based on their correlation to the first impression. For example, if the first impression is benign, the entries would be sorted so that a default entry for lesion boundary would be listed first so the clinician does not have to go through the drop down menu one-by-one or all radio button selections. Optionally, all the entries in a set of available entries for a field would be sorted in descending order based on their correlation to the first impression.

Alternatively, entries in the list or drop-down/select list/check box can be visualized according to the first impression. For example, if the diagnosis is malignant, “Spiculated” and “Irregular” in the “Margin” feature list are highlighted in a color different from that of “circumscribed.” Other optimization algorithms are also contemplated herein.

Optional CDS module 222 also processes the selected image data. In the illustrated embodiment, the CDS module 222 processes the selected image data and evaluates the entries populated in report generated by the interactive report populator 214. If the CDS module 222 identifies a discrepancy between a clinician or auto-populated field entry and what the CDS module 222 believes the entry should be, the CDS module 222 generates a signal indicating the discrepancy.

The CDS module 222 can be automatically activated in response to selecting the image study. Alternatively, the CDS module 222 can be automatically activated in response generating the report. Alternatively, the CDS module 222 can be automatically activated in response to receiving the first impression. In yet another instance, the CDS module 222 can be manually activated, for example, based on demand, by the clinician. Additionally or alternatively, the CDS module 222 processes data sensed by sensors (e.g., vital signs, etc.), a camera, a video recorder, etc.

The CDS module 222 can employ computer vision (e.g., segmentation, feature calculations), machine learning (e.g. classifier) and/or another approach, and can run in the background, not noticeable to the clinician nor need input from the clinician.

A report confirmer 224 visually presents the populated report and an indication of any discrepancy (in configurations which include the CDS module 222) for confirmation by the clinician. In one instance, a discrepancy is indicated by use of color and/or other visual indicia. For example, if the clinician indicates a lesion is benign, the boundary feature would be automatically or manually filled in as “smooth,” and the discrepancy signal would indicate the CDS module 222 determined the boundary was determined to be “fuzzy” and “irregular.”

Where a discrepancy is identified, the clinician can modify the entry in the field or override the discrepancy. Generally, with an experienced clinician, the more discrepancy that are found, the more likely that the clinician's first impression may be incorrect. With a more junior clinician, discrepancies can be indicated at the feature selection or entry level. This may facilitate mitigating more junior clinicians from mistakenly selecting an incorrect feature descriptor and potentially using it to arrive at a wrong diagnosis.

In response to receiving an input indicating the clinician has approved or confirmed the reported and handled any discrepancy (e.g., modifying a field entry, overriding the warning, etc.), the report confirmer 224 finalizes the structured report and conveys the report to the one or more data repositories 120.

FIG. 3 illustrates an example flow chart in accordance with the disclosure herein.

It is to be appreciated that the ordering of the acts in the methods described herein is not limiting. As such, other orderings are contemplated herein. In addition, one or more acts may be omitted and/or one or more additional acts may be included.

At 302, the experience level of the clinician is identified.

At 304, it is determined whether the clinician is experienced. This can be based on a predetermined threshold level of years of experienced, which may be standardized (e.g., internationally, nationally, regional, etc.), facility specific, etc. Other information that can be utilized may include the number of cases evaluated by the clinician and/or a number of reports generated by the clinician, etc.

If at 304 the clinician is deemed experience, then at 306, the clinician is prompted for a first impression and the apparatus 102 receives the first impression given by the clinician. For example, where the tissue being evaluated is a lesion, the first impression may be benign or malignant.

At 308, a sub-set of the fields of the report are auto-populated based on the first impression. As discussed herein, this can be achieved based on a set of predetermined entries for the first impression. Where the first impression is benign or malignant, there may be a first set of predetermined entries corresponding to benign and a second different set of predetermined entries corresponding to malignant.

At 310, the clinician populates the remainder of the fields. As described herein, the fields can optionally be ordered and clustered and/or available entries for a field can be sorted based on the first impression.

If at 304 the clinician is deemed more junior, then at 312, the clinician is prompted to manually populate all of the fields of the report.

At 314, the populated report is compared against a CDS based assessment of the patient data.

At 316, any discrepancy between the populated report and the CDS is resolved.

At 318, the report is confirmed by the clinician. This may include modifying auto and/or manually populated fields and/or overriding one or more discrepancies.

At 320, the report is saved.

The above may be implemented by way of computer readable instructions, encoded or embedded on computer readable storage medium, which, when executed by a computer processor(s), cause the processor(s) to carry out the described acts. Additionally or alternatively, at least one of the computer readable instructions is carried by a signal, carrier wave or other transitory medium.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A method for populating fields of an electronically formatted structured medical report for patient data, comprising:
receiving a signal indicative of an experience level of a clinician evaluating the patient data; and
in response to determining whether the experience level satisfies a predetermined experience level threshold,
prompting, via a graphical user interface, for an input indicating a first impression based on the evaluation of the patient data;
automatically populating a first sub-set of the fields in the electronically formatted structured medical report based on the first impression;
populating a second different sub-set of the fields in the electronically formatted structured medical report based on an input indicative of clinician selected entries;
finalizing the electronically formatted structured medical report in response to clinician confirmation of the populated electronically formatted structured medical report; and
storing the finalized electronically formatted structured medical report in a data repository.

2. The method of claim 1, further comprising:
prior to populating the second different sub-set of the fields, visually ordering and clustering the second different sub-set of the fields together in the graphical user interface based on the first impression, wherein prior to the visually ordering and clustering, the first and second sub-sets of fields were interleaved.

3. The method of any of claims 1 to 2, further comprising:
prior to populating the second different sub-set of the fields, visually sorting available entries for a field of the second different sub-set of the fields based on the first impression so that a default entry for the impression is visually presented as a first available entry, wherein prior to the visually sorting, the entries were interleaved.

4. The method of claim 3, wherein the available entries for the field are sorted in descending order based on their correlation to the first impression.

5. The method of claim 3, wherein the available entries for the field are visually highlighted based on their correlation to the first impression.

6. The method of any of claims 1 to 5, further comprising:
prompting, via the graphical user interface, for an input indicating an entry for each field in the electronically formatted structured medical report, in response to determining the experience level does not satisfy the predetermined experience level threshold.

7. The method of any of claims 1 to 6, further comprising:
processing the patient data with a clinical decision support module which identifies entries for the fields of the first and second sub-sets;
comparing the entries for the fields of the first and second sub-sets determined by the clinical decision support module with the populated fields of the electronically formatted structured medical report; and
visually presenting information indicating any discrepancy between the entries determined by the clinical decision support module and the populated fields of the electronically formatted structured medical report.

8. The method of claim 7, wherein finalizing the electronically formatted structured medical report includes receiving an input indicative of a confirmation of the populated electronically formatted structured medical report by the clinician.

9. The method of claim 8, wherein finalizing the electronically formatted structured medical report includes overriding discrepancy.

10. The method of any of claims 8 to 9, wherein finalizing the electronically formatted structured medical report includes changing an entry for a field in the electronically formatted structured medical report based on the clinical decision support module identified entry for the field where there is a discrepancy between the clinical decision support module identified entry for the field and the populated field in the electronically formatted structured medical report.

11. A computer apparatus, comprising:
computer readable storage medium (108) including instructions for populating fields of an electronically formatted structured medical report for patient data; and
a processor (104) that executes the instructions to carry out steps of:
receiving a signal indicative of an experience level of a clinician evaluating the patient data; and
in response to determining whether the experience level satisfies a predetermined experience level threshold,
prompting, via a graphical user interface, for an input indicating a first impression based on the evaluation of the data;
automatically populating a first sub-set of the fields in the electronically formatted structured medical report based on the first impression;
populating a second different sub-set of the fields in the electronically formatted structured medical report based on an input indicative of clinician selected entries;
finalizing the electronically formatted structured medical report in response to clinician confirmation of the populated electronically formatted structured medical report; and
storing the finalized electronically formatted structured medical report in a data repository.

12. The computer apparatus of claim 11, wherein prior to populating the second different sub-set of the fields, the processor executes an instruction that visually clusters or orders the second different sub-set of the fields together in the graphical user interface based on the first impression, wherein prior to the visually ordering and clustering, the first and second sub-sets of fields were interleaved.

13. The computer apparatus of any of claims 11 to 12, wherein prior to populating the second different sub-set of the fields, the processor executes an instructions that visually sorts available entries for a field of the second different sub-set of the fields based on the first impression so that a default entry for the impression is visually presented as a first available entry.

14. The computer apparatus of claim 13, wherein the available entries for the field are sorted in descending order based on their correlation to the first impression.

15. The computer apparatus of claim 14, wherein the available entries for the field are visually highlighted based on their correlation to the first impression.

16. The computer apparatus of any of claims 11 to 15, wherein the processor executes an instruction that processes the patient data with a clinical decision support module which identifies entries for the fields of the first and second sub-sets, compares the entries for the fields of the first and second sub-sets determined by the clinical decision support module with the populated fields of the electronically formatted structured medical report, visually presents information indicating any discrepancy between the entries determined by the clinical decision support module and the populated fields of the electronically formatted structured medical report.

17. The computer apparatus of claim 16, wherein the processor executes an instruction that finalizes the electronically formatted structured medical report includes receiving an input indicative of a confirmation of the populated electronically formatted structured medical report by the clinician.

18. The computer apparatus of claim 17, wherein finalizing the electronically formatted structured medical report includes overriding discrepancy.

19. The computer apparatus of any of claims 17 to 18, wherein finalizing the electronically formatted structured medical report includes changing an entry for a field in the electronically formatted structured medical report based on the clinical decision support module identified entry for the field where there is a discrepancy between the clinical decision support module identified entry for the field and the populated field in the electronically formatted structured medical report.

20. A computer readable storage medium encoded with computer readable instructions, which, when executed by a processer, causes the processor to:
prompt, via a graphical user interface, for an input indicating a first impression based on the evaluation of patient data;
automatically populate a first sub-set of fields in an electronically formatted structured medical report for the patient data based on the first impression;
populate a second different sub-set of the fields in the electronically formatted structured medical report based on an input indicative of clinician selected entries;
finalize the electronically formatted structured medical report in response to clinician confirmation of the populated electronically formatted structured medical report; and
store the finalized electronically formatted structured medical report in a data repository.
